(19) United States
(12) Patent Application Publication
(10) Pub. No.: US 2013/0166418 A1
(43) Pub. Date: Jun. 27, 2013

(54) METHOD FOR CREATING AND DISTRIBUTING SPONSORED EVENT PHOTOGRAPHS

(71) Applicant: Peter H. Wolf, Thousand Oaks, CA (US)

(72) Inventor: Peter H. Wolf, Thousand Oaks, CA (US)

(21) Appl. No.: 13/335,588

(22) Filed: Dec. 22, 2011

(51) Int. Cl. G06Q 30/00

(52) U.S. Cl. 705/27.1

(57) ABSTRACT

A method for providing online event photographs includes the steps of capturing multiple photographs during an event, and associating identifying data with each photograph taken. A database is accessed to search for the photograph utilizing the identifying data. The photograph is associated with a sponsor, and a machine readable code or image linked to the sponsor's website, digital file and the like is permanently associated with the photograph. This allows the photograph to be offered at a reduced price or for free.

### BACKGROUND OF THE INVENTION

The present invention generally relates to event photography. More particularly, the present invention relates to a method for improving the ordering and distribution of event photographs by utilizing advertisers or sponsors.

Sporting event photography is well known in the art. Photographs are taken of the event participants during the sporting event. Such sporting events include bicycle races, marathons, triathlons, etc. Preferably, the entire participant is photographed at a scenic point along the route, at the finish line, etc., so as to be interesting and capable of being purchased as a memento or keepsake of the event.

Traditionally, sporting event photography has relied on identifying markings commonly known as “bib numbers” that are attached on event participants, such as runners or bicycle riders, so as to be easily visible. Event photographs were taken along the event route or finish line and then developed or scrutinized for the identifying markings of each event participant. The name and mailing address of event participants who are identifiable by their bib number markings were then cross-checked to an address roster of the event participants that lists all the event participants, their bib or identification numbers, and their addresses. Thumbnail photographic images were then printed and mailed to the event participant, along with an order form to be filled out and transmitted back to the photographers by mail, fax, etc., accompanied by a check, money order or credit card authorization. Upon receipt of the order form, photographs were then developed and mailed back to the event participant to complete the transaction.

More recently, this process has been improved by offering the photographs via a website. U.S. Pat. No. 6,985,875 and No. 7,047,214 by the present inventor addresses this solution and are incorporated by reference herein. Wherein the traditional method was very costly due to multiple mailings between the photographer and event participants, and required several weeks or even months of time before event photographs were delivered, the inventor's online method provides the photographs very rapidly, usually within a few days or immediately via email or electronic transfer, and at a substantially reduced cost. Moreover, the sporting event participants do not need to be identified by their bib numbers, but can be identified by their name, race (RFID) chip or the approximate time the photograph was taken.

Although this method improved the overall ordering process of event photographs, a few problems still existed. First, it was difficult to attract potential customers to the website to search for their pictures. Second, there was the ongoing problem of enticing the customers to order the pictures or products. Methods of dealing with these drawbacks included promoting, announcing and encouraging customers to search for their pictures; emailing potential customers a hyperlink to their picture; emailing potential customers a proof of their picture in very low resolution or quality; and mailing potential customers a proof of their picture with an order form or link to the website. However, these methods were found to have limited success.

These drawbacks led the present inventors to create an advertising and distribution method for event photographs, as disclosed in U.S. Pat. Nos. 7,835,947 B2 and 7,870,035 B1. This method involves the creation of a field in the digital photograph into which visual advertisement indicia, such as an advertiser's name or logo is placed within the picture. In another embodiment, an electronic link, such as in the form of a hyperlink, was associated with the photograph such that when the hyperlink was activated by clicking with a mouse pointer, the user would be connected to an advertiser's electronic document or website. This enabled the event photograph to be offered to the consuming public at a reduced price or even for free.

However, this method has been found to have some drawbacks as well. Connecting to the advertiser's website or digital documents requires activation of the electronic hyperlink, which is only available when viewing the digital photograph. Once the photograph is printed, there is no longer any means or manner to connect the user to the advertiser's website. Furthermore, it has been found that once the digital photograph is transmitted, such as to a social website, including Facebook or the like, the electronic hyperlink is lost, preventing any subsequent viewers from activating the link and obtaining additional information about the advertiser, such as through its website or the like.

Accordingly, there is a continuing need for a method of improving the number of potential customers who visit the website to search for and order event photographs after an event has occurred. There is also a continuing need for additional revenue streams to event photographers. There is also a continuing need for creating and providing an event photograph which a viewer can link to an advertiser's or sponsor's website or other digital files regardless if the photograph is printed, transmitted to websites or the like. The present invention fulfills these needs and provides other related advantages.

### SUMMARY OF THE INVENTION

The present invention resides in a method for providing online event photographs in a manner which increases the number of potential customers who visit the server to search for and order event photographs after the event has occurred. One aspect of the present invention is to offer a photograph at a substantially reduced price, or preferably for free, as an enticement for event participants to visit the website. The present invention also provides means for sponsors to directly advertise to the event participants. Such advertisements can be a source of income for event photographers, event organizers or web hosting companies.

The present invention comprises the steps of capturing multiple photographs, typically individuals, during an event. The present invention is particularly suited for capturing sporting event participants during a sporting event. Identifying data is associated with each photograph taken. For example, the identifying data may be at least one of: a time the photograph was captured, a name of the individual photograph, a number worn by the individual photographed, or a code from a device worn by the individual photographed.

A user is sent a hyperlink of the picture location on a server typically along with a sample picture via email or some other electronic means or the user accesses the database, usually a server, and searches for a photograph utilizing the identifying data. This may occur at the event or more typically at a location other than at the event. In response to the identifying data search, one or more photographs are posted. These photographs may be relatively small images of a low quality resolution. Alternatively, or in addition to, the photographs may contain a watermark. These photographs are not intended for printing or downloading and keeping as a memento or keepsake, but rather are to assist the user in selecting and ordering a photograph.

Once the user has selected a digital photograph to be ordered, an order screen enables the user to purchase the photograph. In accordance with the present invention, if the user desires to obtain the photograph at a significantly reduced cost, or for free, the user makes the selection. In response, a final digital photograph is created. This final digital photograph is preferably of a higher resolution and without the watermark so as to be desirable as a memento or keepsake.

It is contemplated by the present invention that as an alternative to the sporting event participant or other user/requester searching for and ordering photographs from the photographer's database or server, that it is the photographer, sponsor, or some other host or entity which searches for photographs of each sporting event participant utilizing the identifying data and selecting one or more of those photographs to automatically send to the sporting event participant or a requester free of charge as a service courtesy of the one or more sponsors. Supplying free photographs to each of the sporting event participants would benefit the event due to the increased value of registering for the event by obtaining one or more free pictures, as well as the one or more sponsors which are interested in delivering as much goodwill and advertising to the participants of the event as possible.

Once the final digital photograph has been selected and/or ordered, an electronic device is utilized to associate a machine readable code or image with the photograph. The machine readable code or image may be visible or invisible to the human eye. The machine readable code or image may comprise a holograph, a quick response code, a barcode, a magnetic code, or a sponsor or photographer scanable indicia or any other such code or image scanable and readable by a machine. A field may be created within the photograph or a border of the photograph into which the machine readable code or image is inserted. Visual advertiser or sponsor or photographer indicia may also be inserted within the field. Typically, the field is created in a corner or margin of the photograph. The machine readable code or image is permanently associated with the photograph, such that upon using a machine to read the machine readable code or image, whether in digital form or printed, a digital document, a digital file, or a webpage linked to the sponsor or photographer of the photograph is displayed on an electronic display associated with the machine.

The selected and ordered final digital photograph, containing the visual field advertiser indicia, is electronically transferred to the user's electronic device, such as a computer or a wireless device such as a cell phone or portable digital audio/visual players. This may be done by downloading the digital photograph, either automatically or upon the user's request, to the user's electronic device. Alternatively, the digital photograph, or a link to the digital photograph, is electronically mailed to the user. The final digital photograph may be enjoyed and viewed only on the electronic device, or more preferably, can be saved, forwarded to friends and family members, or even printed. Using the method of the present invention, since the machine readable code or image is permanently associated with the photograph, the photographs may be professionally printed and mailed to the user as well.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a flow diagram depicting the steps of searching for a photograph, in accordance with the present invention;

FIG. 2 is a diagrammatic view of an order screen for ordering photographs, in accordance with the present invention;

FIG. 3 is a diagrammatic view of an order form to order a photograph at a reduced cost or for free, in accordance with the present invention;

FIG. 4 is a diagrammatic view of an event photograph taken in accordance with the present invention, and having a machine readable code associated therewith;

FIG. 5 is a diagrammatic view illustrating a machine reading the code, and displaying an advertiser's or sponsor's digital file, document, website or the like in accordance with the present invention;

FIG. 6 is a diagrammatic view of another event photograph having a code, photographer indicia, and sponsor or advertiser indicia, in accordance with the present invention;

FIG. 7 is a diagrammatic view similar to FIG. 4, but wherein the machine readable code is transparent or semi-transparent to the human eye;

FIG. 8 is another diagrammatic view of an event photograph, containing a holographic image as the code used in accordance with the present invention;

FIG. 9 is a diagrammatic view of an event photograph having a margin including photographer or sponsor logos and related machine readable codes;

FIG. 10 is an exploded diagrammatic view illustrating the embedding of a machine readable code into the event photograph; and

FIG. 11 is a diagrammatic view, illustrating a machine scanning and reading the embedded code of FIG. 10, in accordance with the present invention.

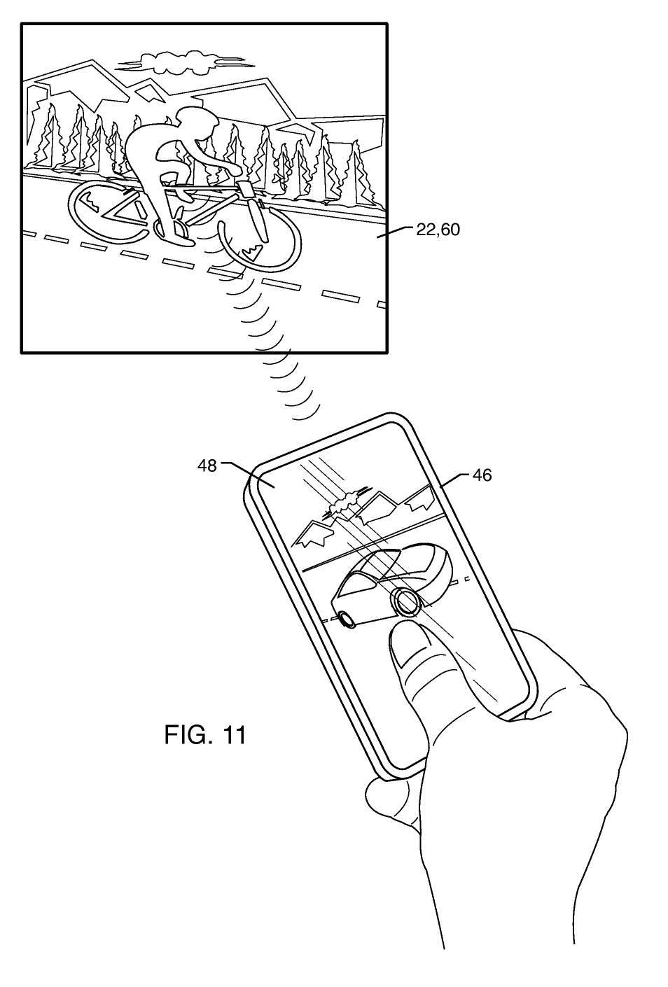

### DETAILED DESCRIPTION OF THE PREFERRED EMBODIMENTS

As shown in the accompanying drawings, for purposes of illustration, the present invention resides in a method for creating and distributing event photographs. More particularly, the present invention resides in a method for providing event photographs at a reduced fee, or preferably for free by permanently associating a machine readable code or image relating to a sponsor of the photographs. This is intended to provide an enticement for customers to visit the event photographer's server, such as to order other pictures. As will be more fully described herein, the methodology of the present invention also enables directed advertising to the event participants, and provides an additional revenue stream for the event photographer, event organizer or web hosting company.

As described in U.S. Pat. No. 6,985,875, which is incorporated by reference herein, hundreds or even thousands of photographs can be taken at a given event. For example, during a triathlon or marathon, it is common for an event photographer to contract with the event organizer to take photographs of all the event participants. As described above, these event photographs are later presented to the event participants for ordering. The '875 Patent describes a methodology of associating identifying data with each of the photographs which identifying data can be used to search for the photographs online, and subsequently order the photographs.

In a typical sporting event, such as a bicycle race, triathlon, marathon or the like, the event participants have registered for the event and have provided, among other information, their name, email and address. Each event participant is typically given a bib number or wristband to wear for identification purposes. Alternatively, or in addition to, in some events the participants may be given a passive, active electronic or Global Positioning System (GPS) recording device having a unique code and which is typically for timing purposes. Identifying data, in the form of the event participant's name, bib number, device code, or the time the photograph was taken, is associated with each photograph. Those skilled in the art will appreciate that larger events, such as a marathon in a large city, may result in many thousands of pictures being taken of the event participants. Accordingly, the identifying data permits the event participants to search for their pictures. If the event participant was not able to be identified by name or bib number, the event participant can search by the approximate time or GPS location when the photograph was taken.

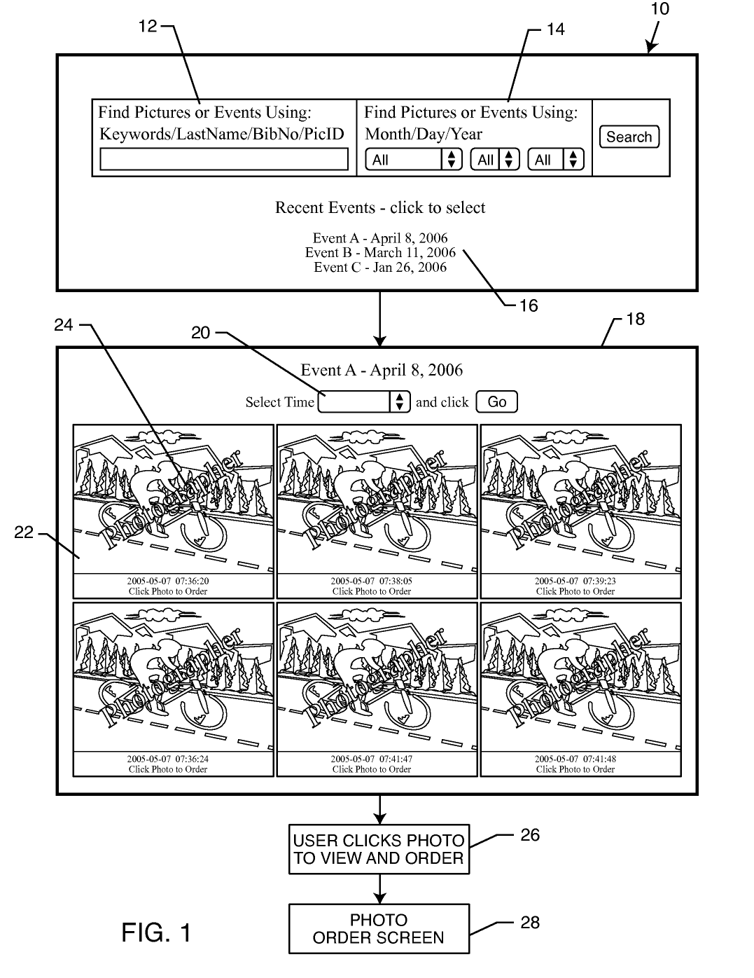

With reference now to FIG. 1, the digital photographs, catalogued by the identifying data, are saved in a database, such as on a server, for searching, viewing and ordering through an electronic network, such as the Internet. Although this may occur at the event, typically the photographs are searched for and ordered at a location other than the event, such as when the event participant visits the event photographer's website at his or her home, office, using a computer or portable electronic device. The location of the saved photographs, typically the event photographer's or web-hosting company's server, is provided to the event participants in their registration materials, at the event, in subsequent email messages or mailings to them. When visiting the server or website, a webpage or window 10 is displayed, and the event participant is provided with the opportunity to search for their pictures. Search boxes 12 and 14 may include entering a key word such as the name of the event participant, their bib number, electronic code, picture I.D. (if known) or the like. Alternatively, or in addition to, the event participant may be provided with an opportunity to find the pictures using a time. Initially, the event participant may select a date of the event, such as using box 14 in FIG. 1, or clicking a link to the event 16.

The user is then transferred to another server or website page 18 containing information specific to the event and possibly containing a number of photographs, or even the photographs taken of the event participant if the initial identifying search data was specific enough to limit the selection of photographs to just the event participant's photographs. If the event participant selected the electronic link to the event or the date of the event, a more specific time 20 that the photograph was taken may be requested from the user so that photographs 22 taken approximately at that time are displayed to the user. As illustrated in FIG. 1, the user may be able to select the number of pictures per page, search by pages of photographs, or other identifying data as described above.

When the digital photographs 22 are displayed on the monitor, they are typically presented as a small image, such as a thumbnail image. Moreover, the digital photographs 22 are typically of a relatively low resolution or quality which is sufficient to identify the event participant, but which would not be desirable for downloading or printing as a memento or keepsake. Furthermore, the digital images 22 may be labeled with a large watermark 24. These steps are taken to discourage the user from downloading or printing the picture from the website without ordering the picture. However, it will be appreciated by those skilled in the art that the use of a lower quality image or a watermark 24 is not necessary if a machine readable code or image is permanently associated with each selected photograph, as will be described more fully herein, as it is an intention of the present invention to provide the photographs for free to the requesters and have a sponsor which pays the photographer to associate the machine readable code or image with each selected photograph, the machine readable code or image being capable of conveying information relating to the sponsor. The use of low quality images and/or watermarks may be used in the event the requester is paying for an event photograph, such as one that does not include a machine readable code or image, or if it is part of the process the requester must provide information when ordering the photograph.

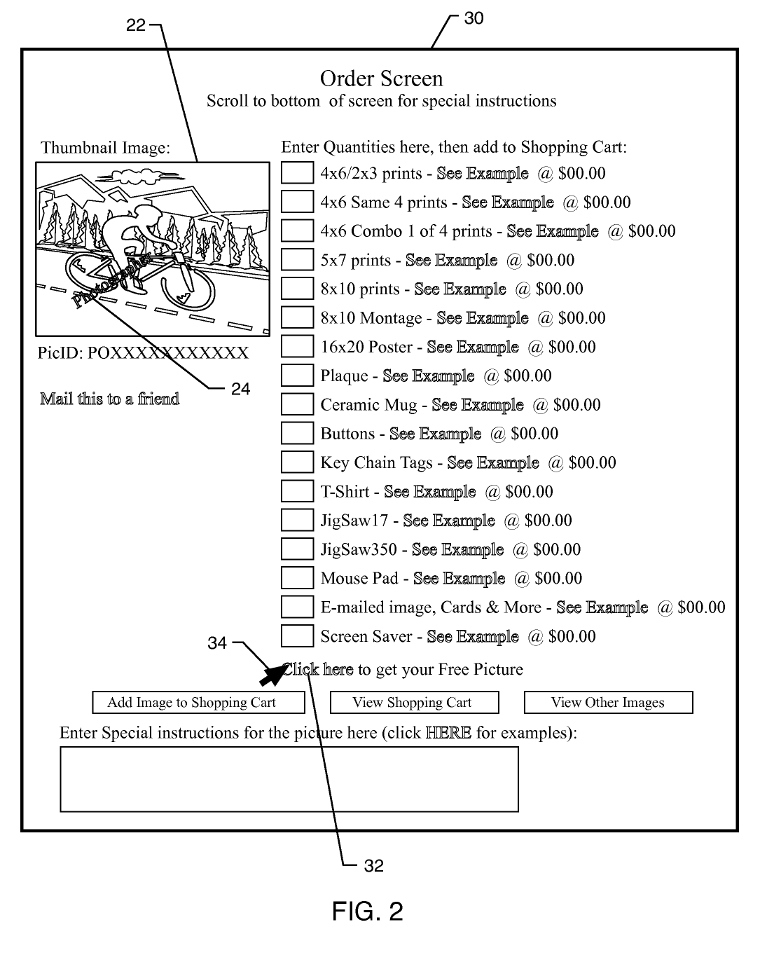

The user selects a photograph, typically by clicking on the photograph to view and order that photographic image 26. The user is then transferred to a photograph order screen or window 28. A representative photograph order screen 30 is shown in FIG. 2. Typically, the selected image 22 is shown on the order screen. This image 22 may be of the same small size as in the previous web page, or enlarged for better viewing. However, the photographic image 22 may still include the watermark 24 labeling and/or is of a low quality resolution. The order form 30 allows the user/requester to order various sized photograph prints, posters, plaques, etc. The photographs can be professionally printed in various sizes, or imprinted onto various products, as shown in the order form 30 of FIG. 2. Quality resolution images can also be ordered which will be emailed to the requester. The cost for these vary between event photographers and the products selected. It will be appreciated that the vast majority of sales of the photographs are made shortly after the sporting event. As more time passes, the emotional attachment to the event and the interest in obtaining a photograph thereof diminish. Thus, it is important to direct the sporting event participants to the website as quickly as possible.

The inventor has found that offering a photograph at a very low price, or preferably even for free, satisfies many of these needs. As shown in FIG. 2, the order screen 30 includes a link 32 to “click here to get your own free picture”. This may be done, for example, using a curser 34 operated by a mouse or the like. This webpage or order screen may also include information identifying the sponsor or advertiser, and the fact that the sponsor or advertiser is providing the photograph to the requester at a reduced price or free of charge.

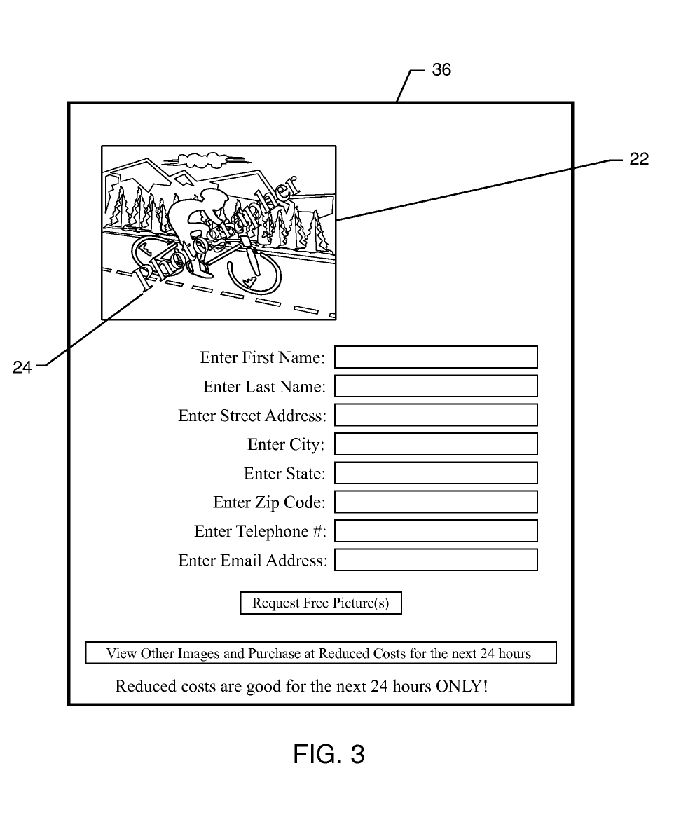

With reference to FIG. 3, the user is typically presented with an order screen or form 36 for obtaining the free picture. The event participant may be required to enter personally identifying information, such as their name, address, telephone number, email address or the like, as illustrated in FIG. 3. This information can be used to electronically transfer or mail the picture to the event participant. Moreover, the photographer may utilize this personally identifying information for later sale to event organizers, advertisers and the like. For example, the event participant may be required to enter their name, zip code, telephone number, email address or any combination of these items. This will enable third parties to contact the event participant with targeted advertising and marketing campaigns. For example, if the individual ran in the Santa Barbara Marathon, the organizers of the Los Angeles Marathon may desire to contact that individual directly to seek registration in its event. Similarly, running shoe companies, companies representing magazines, etc., may wish to contact the event participant directly for targeted advertisement purposes. The sale of such personally identifying information provides a source of income to the event photographer. The requester/event participant may be informed that as a condition of receiving the picture for free or at a significantly reduced price, the participant's information will be made available to third parties, such as the event organizer, advertisers, etc.

Of course, if the event photographer decides to keep the personally identifying information confidential, this information can still be used to send the picture to the requester, as described above. Also, this information can be used to verify that the sporting event participant is on the roster for the event. Such information can be used to limit a sporting event participant to only a limited number of free pictures, so as not to adversely impact sales of printed photographs and products. The event photographer can adequately control the number of free pictures when an attendance roster is available. However, when there is no attendance roster, an unscrupulous event participant could potentially obtain multiple free pictures. To prevent this, each request for a free picture could place a cookie on the recipient's computer, and a second request could be denied if the cookie is detected. Alternatively, all email addresses are logged whether they are associated with valid or denied entries. Users are required to use valid email addresses. Thus, regardless of the name inputted into the website, as long as someone has used an email address more than once for any event, the request is denied. Another method of preventing abuse of the free pictures is to match the event participant's last name entry to a previously entered identical email address from any event. These safeguards can be implemented to protect the event photographer from losing potential photograph and product orders by those who would abuse the system when only a single picture or a limited number of free pictures are made available to each event participant.

Once the requester/event participant has provided the necessary personally identifying information and has requested a free picture, as an incentive to order additional pictures and products, a discount may be provided to the event participant. For example, for a limited time, such as twenty-four hours, additional pictures, plaques, etc., could be ordered at the provided discount. This is intended to entice the event participant to order other products shortly after the event while there is still an emotional attachment to the event.

In accordance with a particularly preferred embodiment of the present invention, one or more sponsors contract with the event photographer and pay the event photographer a predetermined fee to provide event photographs to the event participants at a reduced fee or even free of charge. The captured photographs of the sporting event participants during the sporting event which are to be sent to the sporting event participants after the event are each permanently labeled with a machine readable code or image linked to the sponsor. This provides a source of advertising for the sponsor. Depending upon the arrangements, a single photograph having such machine readable codes or images associated therewith may be offered to the event participants at a reduced fee or for no charge, a predetermined number of photographs may be offered at a reduced fee or for no charge to the event sporting participants, or all of the photographs for any given sporting event participant may be offered at a reduced charge or for free.

The sporting event participants may also subsequently receive mailed or emailed advertising from the sponsor after the event. The sporting event participant's information may be obtained from the sporting event registration roster or from the personally identifying information received when ordering the pictures, as illustrated in FIG. 3. The steps in accordance with the present invention illustrated in FIGS. 1-3 may be performed by the sporting event participant after finishing the event, or another requester such as a friend or family member or the like. However, it will also be appreciated that in accordance with the present invention due to the fact that a sponsor has essentially pre-paid for all of the sporting event photographs, one, multiple, or even all of the photographs of each sporting event participant may be available for ordering by the sporting event participant or other requester. Alternatively, the one or more free photographs of the sporting event participant may be automatically sent to the sporting event participant by the photographer, event, sponsor, or other entity administering the invention. Such transfer can occur by means of email, directly to social media accounts such as Twitter or Facebook, user of a link enabling downloading of the photographs, or mailing actual copies of the printed photographs. Typically, the event will be provided each event participant's mailing address and/or emailing address as part of registering for the event.

It will be appreciated that the use of small, low resolution and/or watermarked photographs as a precaution to prevent the user from downloading the photographs is only necessary when a single or limited number of free photographs are offered to the sporting event participants or requesters or if personally identifying information is needed through the ordering process. If all of the photographs of the sporting event participant are available for free and no additional information of the sporting event participant is needed, the safeguards are not necessary. Instead, each of the photographs will have permanently associated therewith a machine readable code or image before being presented for viewing, downloading, etc. Once the necessary information is received, a photograph with the machine readable code or image is transferred to the requester. This is typically done by enabling the requester to download the image to his or her computer, other electronic devices such as cell phones or portable digital audio/visual players, or email the image or a link to the downloadable image is sent to the requester. Of course, an actual printed picture may also be mailed to the requester. Since this requires that the event photographer incur an additional cost, a small charge may be applied to such instances of hard copy mailing.

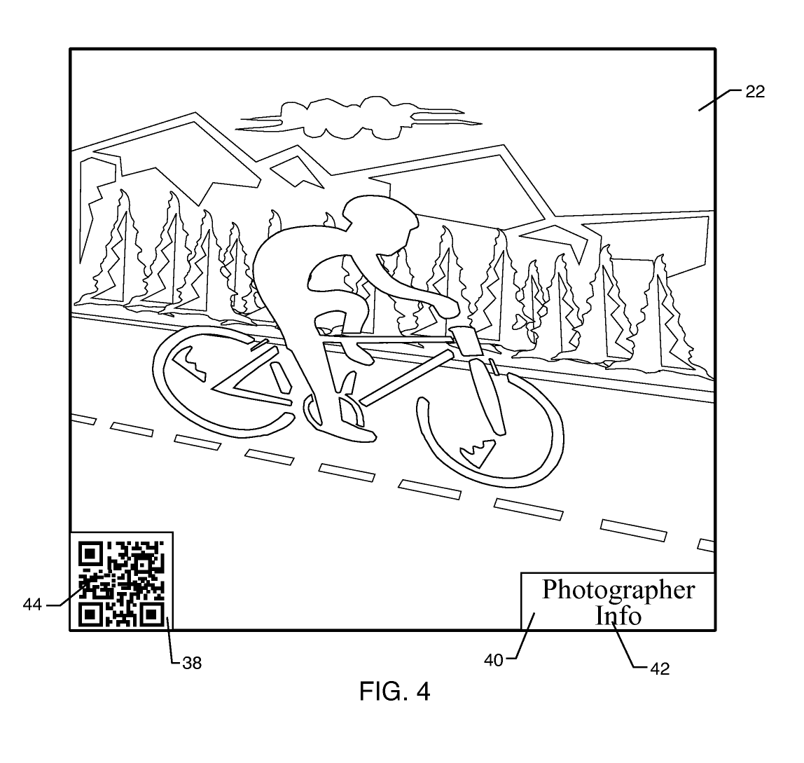

There are a variety of ways of permanently associating a machine readable code or image with a photograph. Such machine readable code or image must be able to be read with a machine and subsequently link the user to a digital document, a digital file, a website or the like so as to provide the user additional information regarding the advertiser or sponsor of the code or image. As illustrated in FIG. 4, one method of permanently associating such machine readable codes or images is to create fields 38 and 40 in the photograph 22. Usually, these fields 38 or 40 are positioned in the photograph 22 so as not to obstruct the event participant that was photographed. Such fields 38 and 40 are preferably created in the corners or along a margin, such as the upper, lower, or a side margin of the photograph 22 so as to have a minimal impact on the content of the photograph 22. The fields such as 38 and 40 are preferably translucent to further minimize the impact on the content of the photograph 22. The one or more fields 38 and 40 are imbedded with advertisers' names or logos, such that the advertisers' desired information is viewed in the digital photograph and preferably also viewable when the photograph 22 is printed. The fields 38 or 40 within the image could identify the photographer and also contain the photographer's copyright information 42. The one or more visual fields 38 and 40, essentially comprising “real estate” on the photograph, can be sold to one or more advertisers or sponsors. Such advertisers could comprise the event photographer, the event organizer, or other advertisers who wish to directly target the event participants. For example, with sporting events, such advertisers may comprise nutrition supplement companies, shoe companies, magazine companies, etc.

Although multiple advertisers can be present in a single photograph, it is preferable that only a single advertiser or sponsor is present. Thus, if multiple advertisers are interested in purchasing “real estate” or fields on photographs of a given event, the event photographer or web-hosting company can assign a given number of photographs to each advertiser. For example, if there are 10,000 pictures posted on the server for an event, and there are three sponsors for which to purchase ad space, the total ad campaign can be sold for $10,000 (i.e., one sponsor on each of the 10,000 pictures for $1.00 per ad space). Sponsor A purchases $2,000 worth of ad space, sponsor B purchases $3,000 worth of ad space, and sponsor C purchases $5,000 worth of ad space. Thus, sponsor A's ad space will be placed on 2 out of every 10 pictures; sponsor B's ad space on 3 out of every 10 pictures; and sponsor C's ad space on 5 out of every 10 pictures. Software can be used to assign such ad space randomly.

The advertiser sponsor receives direct benefit in that the event participant, when viewing his or her pictures also views the logo and/or typed message in the ad space. Thus, the advertiser can target thousands of individuals directly after the event. Such advertisers can include the sponsors of the event, although the invention is not limited to such.

In one embodiment of the present invention, as illustrated in FIG. 4, a machine readable code 44, such as the illustrated quick response or QR code 44 is inserted into the created field. It will also be appreciated that the insertion of such a code 44 into the photograph 22 is deemed to have created a field for the code 44 in the photograph 22, even if additional steps to create such a field 38 are not taken. The code 44 is permanently associated with the photograph 22, such that when the photograph 22 is printed, emailed, downloaded, transferred to other websites including social media websites and the like, the code 44 remains with the photograph. In the case of the photograph 22 illustrated in FIG. 4, the QR code 44 will always be seen and can be read by an appropriate machine. The machine readable code is not limited to a QR code, but could comprise other known codes or any code which is capable of being scanned and read by a machine, including QR codes, barcodes, other two-dimensional codes, three-dimensional codes including holograms, a magnetic code, a scanable image, an embedded and invisible code, a stream of alpha and/or numeric digits, etc.

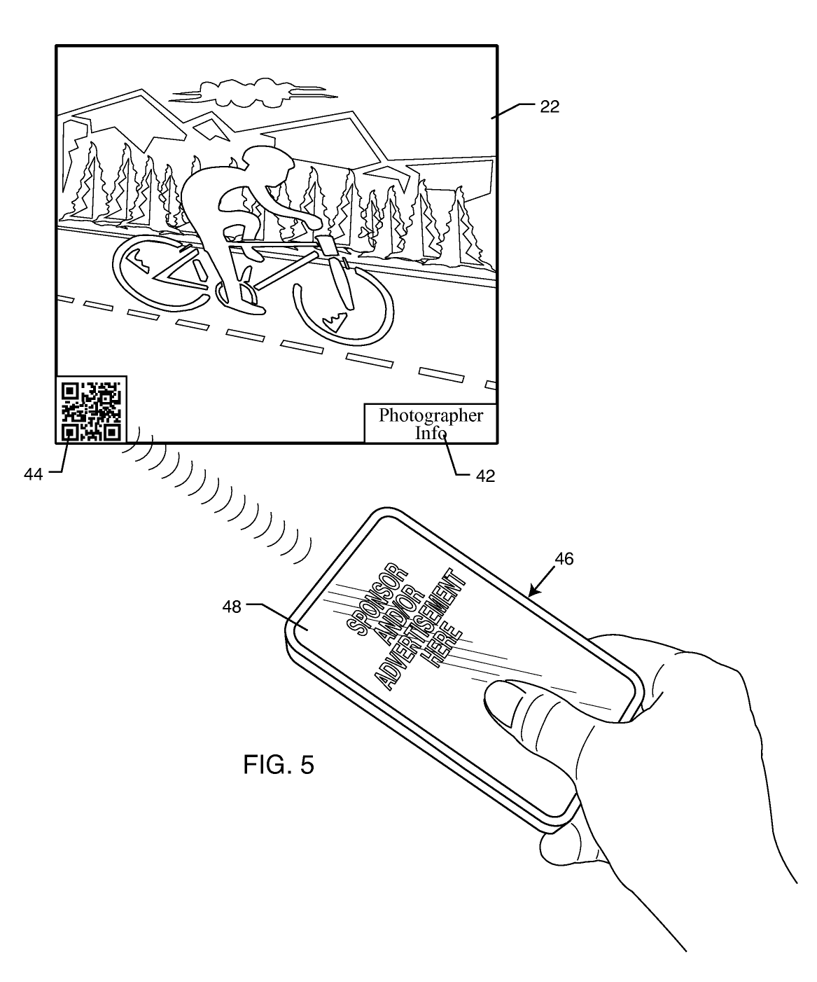

With reference now to FIG. 5, the photograph 22 is shown with the QR code 44, as well as optional photographer information 42. Utilizing an appropriate machine 46, the user scans the code 44. A display 48 associated with the machine 46, after scanning and analyzing the code 44, displays a webpage, a digital document, a digital file, etc. associated with the advertiser or sponsor. Such a digital document or file could comprise not only the sponsor's website and webpages, but also additional advertising brochures, redeemable offers, videos, etc.

The machine 46 is typically electronic in nature so as to include a microprocessor, memory, and network connection capability. It is anticipated that the machine 46 typically comprise a smart phone or hand-held personal digital assistant device or the like which has scanning or reading capabilities along with the necessary microprocessor, software, and display 48. Upon scanning the code 44 with the device 46, the server containing the digital document, file, website, video, etc. is accessed and the device 46 is connected thereto, so as to display the document, file, webpage, etc.

It will be appreciated that the displayed digital document, file, webpage, video, etc. provides additional advertising and product or service informational opportunities for the sponsor or advertiser, which can be very valuable to the sponsor or advertiser. Since the preferred embodiment of the present invention is to capture photographs of sporting event participants during a sporting event, the sponsors and advertisers know certain characteristics of the participants. For example, such sporting event participants are usually young adults or adults which are interested in a particular sporting event activity and typically have a greater disposable income than the average person. Although not limited to such, the sponsors could represent shoe companies, bicycle companies, sportswear companies, sports drink and bar product companies, etc. which could very specifically direct advertising to their products and services to the end users likely to consume such products and services. Such targeted advertising is often difficult to achieve, and thus the sponsors or advertisers will find a great benefit in sponsoring the free photographs to the sporting event participants, which also benefits the event photographer as well as the sporting event participants.

Once the “final” photograph having the permanently associated code 44 is created, it is transferred to the requester. This transfer typically occurs by means of emailing the photograph to the requester or enabling the photograph to be downloaded to the requester's computer or other electronic devices such as a cell-phone or portable digital audio/visual player. It will be appreciated by those skilled in the art that the transfer can take place by a variety of means. For example, the “final’ photograph can be automatically downloaded to the requester's computer. Alternatively, the photograph is displayed on the requester's monitor such that the requester can download the image, such as by clicking on a “download” button, right clicking the photograph to download it, etc. Alternatively, the digital photograph can be emailed to the requester's email address. This can in the form of an attached file, or the email message may include a link for the requester to obtain a downloaded photographic image containing the code 44. Another method could involve the wireless transfer of the image from the photographer's or web-hosting server to a handheld device such as a cell phone or portable digital audio/visual player. Although the photograph could be restricted to display on the monitor associated with the user's computer only, in a particularly preferred embodiment, the user is able to print the photograph, which would result in the printing of the code and advertiser field information as well. Of course, as described above, the photograph could be professionally printed by the photographer and mailed to the event participant, in lieu of electronic transfer. However, it is anticipated that in most cases the photographs will be electronically transferred, enabling the event participant to print the pictures or email them to family members and friends.

Those skilled in the art will appreciate that the present invention benefits not only event photographers, but also the sporting event participants who receive a free digital image, as well as advertisers/sponsors, web-hosting companies and the event organizer. The event participants are able to obtain good quality free images, which has not been available in the past.

Of course, advertisers/sponsors are able to target their advertisements to event participants, and provide links to their websites to increase traffic and awareness of their websites and related products and services. Event sponsors and advertisers benefit from greater exposure of their logo or advertising message on the free pictures as it has been found that these pictures frequently proliferate among friends or on Internet websites long after the event is over.

The event organizers benefit by offering enhanced services with a free picture to each of their participants, thereby attracting more participants to the event. Moreover, event organizers have the option to charge and justify a modest additional fee for the free picture service in the registration cost. The event organizers now may also negotiate additional costs from sponsors or advertisers who receive ad space in the free pictures.

Currently, event photographers pay event organizers for the opportunity to photograph the event, anticipating that the revenue generated from the sale of the event photographs will exceed the amount paid to the event organizer. However, with the methodology of the present invention, it is contemplated that the ability of the event organizer to offer at least one free picture per event participant may be sufficiently valuable to the event organizer that the event photographer will no longer have to pay such a fee, or that the event organizer could even potentially pay the event photographer to photograph the event and offer the free pictures. It is anticipated that sufficient additional revenue might be generated by the event organizer in registration fees to the event participant registrants to accomplish this. Moreover, the event photographer may obtain sufficient revenue from advertiser sources that all photographs taken during the event could be offered for free, provided they included the advertising fields mentioned above. Alternatively, after the initial free picture, additional pictures could be ordered by the event participant at a modest cost which may or may not include advertiser fields.

The web-hosting company benefits by promoting their own services with each free picture through ad space on the free picture. Currently, event photographers pay web-hosting companies for hosting their event images on the web-hosting company's servers with Internet access. Permission by the photographer to allow web-hosting companies to offer free pictures and/or promote the web-hosting services as ad space on the free picture could offset some or all the fees normally charged to the photographer by the web-hosting company for hosting the event pictures on the web-hosting server with Internet access.

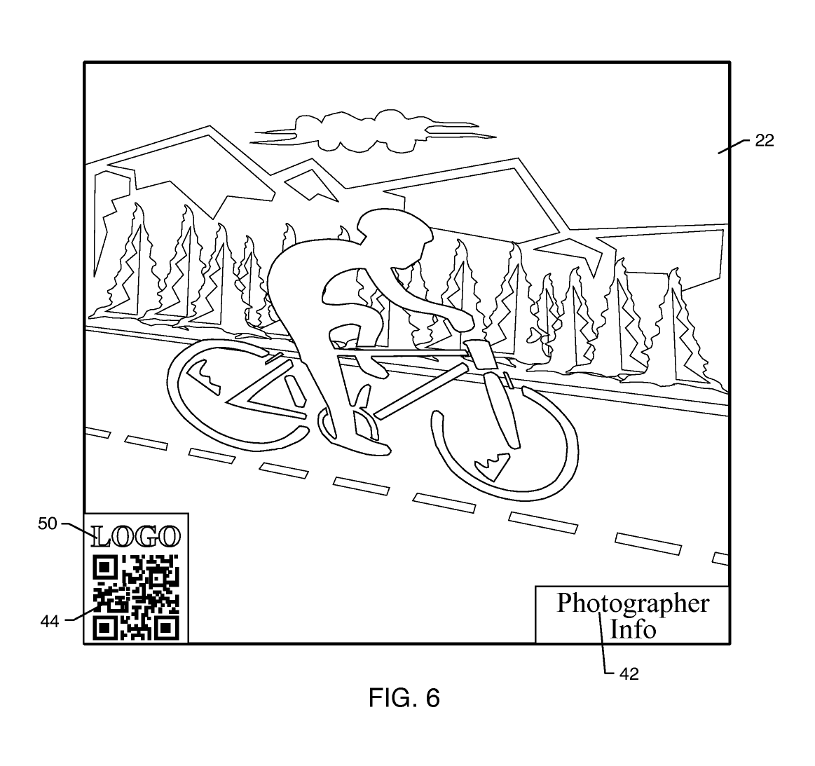

With reference now to FIG. 6, another photograph 22 is shown similar to that of FIG. 4, wherein the photograph 22 includes optional photographer information 42 embedded, printed, or otherwise associated therewith, as well as the code 44 in the form of a QR code. This photograph 22, however, also includes a logo 50 which can represent a sponsor's or advertiser's name, symbol, logo or the like. The logo or sponsor information 50 may be associated with a QR code 44, such that the user can visually read the sponsor's identification indicia or logo 50 and thus know or assume that upon scanning and reading the code 44 with the machine or electronic device that the code 44 will be associated with that particular sponsor having its logo or other indicia next to the code 44.

It will also be appreciated that only the logo or advertiser indicia 50 may be present in the photograph and not a QR code 44 or photographer information 42. In such instance, the sponsor indicia or logo 50 serves as a machine readable code or image which can be scanned by a machine and linked to a predetermined digital file, document, website or the like. For example, the software of the machine may recognize a particular logo or advertiser indicia and connect the user with the server or other source of such digital information regarding the sponsor or advertiser.

It will be appreciated that a particular advantage of the present invention is that the digital document, file, webpage, etc. associated and linked with the machine readable code or image can change over time. That is, scanning or otherwise reading the machine readable code or image can result in different digital documents, files, videos, webpages, etc. being displayed to the user as these change over time. For instance, the sponsor may be an energy sports drink company focusing on a particular sports drink at the time the photograph is created and sent to the requester. Several years later, when the image or machine readable code is scanned and read by an electronic device, the particular products of that sponsor or advertiser may have changed. Information and advertising regarding the new products can be provided to the user by means of the linked document, digital file, webpage, etc. Thus, the code or image does not stale or become irrelevant over time.

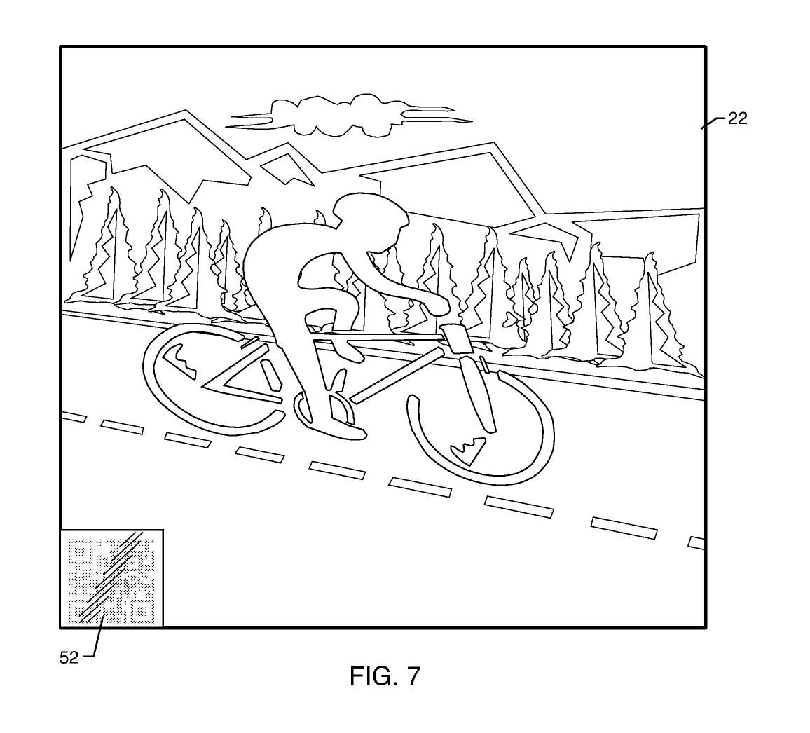

With reference now to FIG. 7, a semi-transparent code or a code which is invisible to the human eye 52 is shown. In this case, the machine readable code or image 52 is not visible to the human eye, or is only faintly visible, but is still capable of being scanned and read by a machine. This could be used in conjunction with a sponsor's or advertiser's logo or other indicia 50, as illustrated in FIG. 6, wherein it only appears to the user that the photograph 22 includes an advertiser or sponsor's logo or indicia, but in fact when scanning the area of the logo or indicia 50, the machine scans a semi-transparent or transparent or otherwise undetectable by the human eye machine readable code or image.

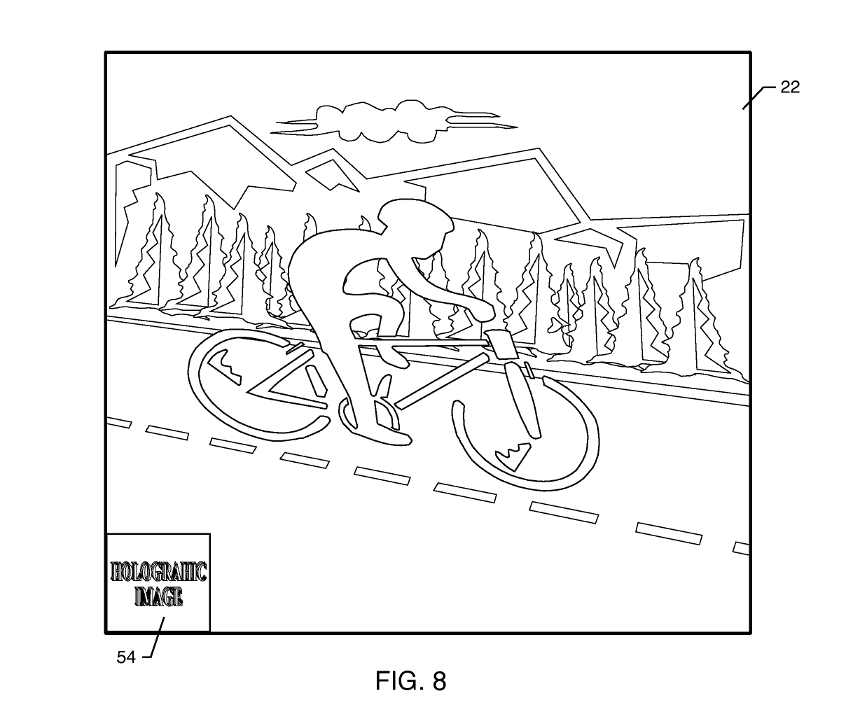

With reference now to FIG. 8, the machine readable code or image is not restricted to a two-dimensional code or image. The present invention contemplates the use of three-dimensional codes or images, such as a holographic image 54, which can contain more information than a two-dimensional code is capable of containing. Such a three-dimensional code or holographic image can also be visually appealing as part of the photograph 22.

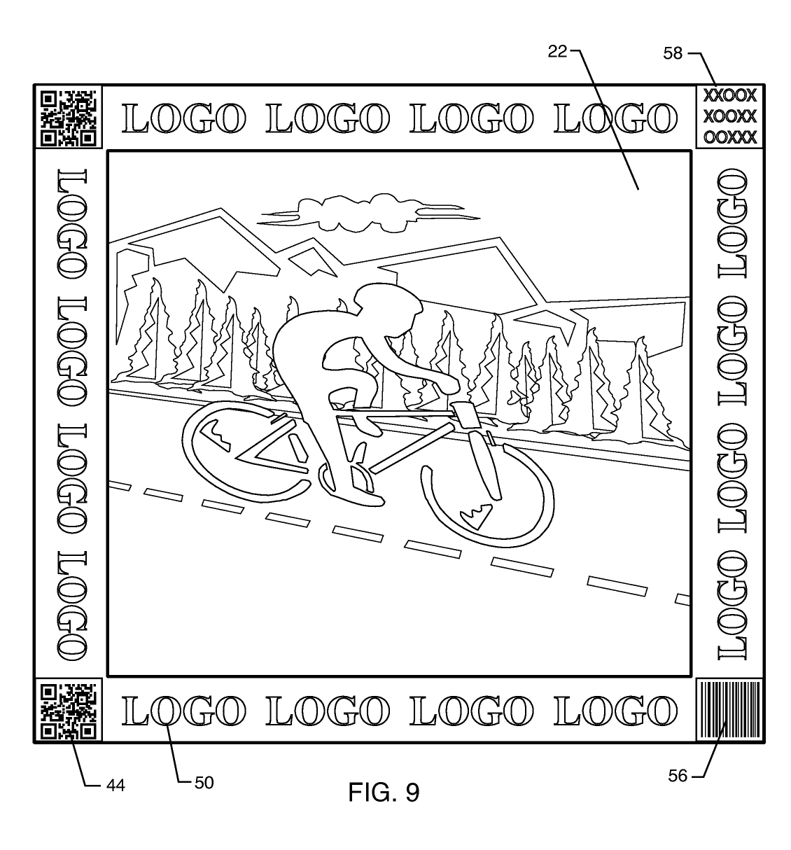

With reference now to FIG. 9, it is contemplated by the present invention that a margin or border be formed around the photograph 22, such that associated codes, such as the illustrated QR code 44, barcode 56, or other “code” 58 can be positioned in the corners, margin, or other border of the photograph 22. It is also contemplated that the one or more logos or indicia of the sponsor or advertisers 50 also be placed in such margin or border. It will be appreciated that the margin or border or corners may only contain the sponsor's or advertiser's indicia or logo 50, that a single code 44, 56, 58, etc. be shown in any portion of the margin, border, or corners, or that multiple sponsor and advertiser's indicia 50 and/or codes be incorporated in the corners, margins, border, etc. The sponsor's indicia, related codes or images, etc. can be used to create a frame-like border around the photograph 22 of the sporting event participant. One benefit to the sporting event participant or requester is that such a border or margin could be placed within a physical frame, thus hiding the advertiser's logo or other indicia 50, codes and images.

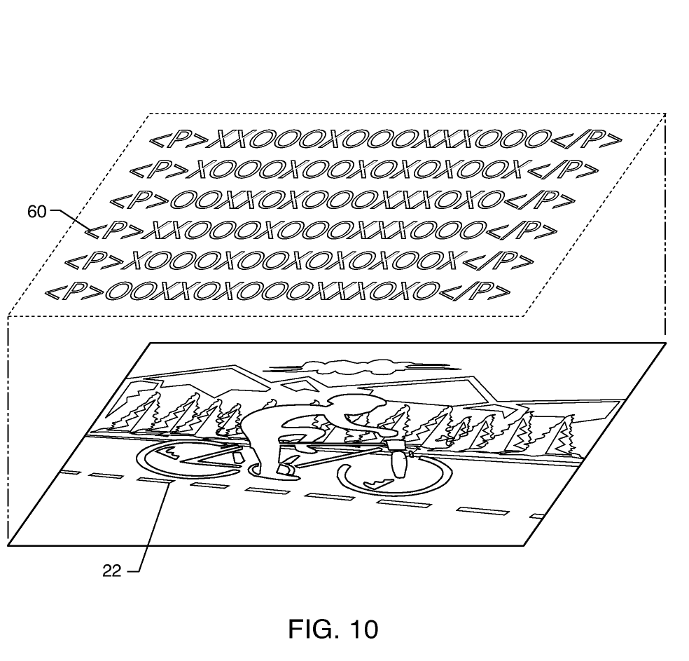

With reference now to FIG. 10, the present invention also contemplates that the machine readable code or image could comprise a digital watermark, such as the illustrated digital watermark 60 of FIG. 10. The photograph 22 would have a digital watermark 60 containing a code or other embedded information which would be embedded into the digital photograph 22 so as to be invisible to the naked human eye, but readily scanable and readable by a machine. This is illustrated in FIG. 10, wherein the photograph 22, including the embedded digital watermark codes or information 60 appears to the naked human eye as only a high quality photograph image without any additional codes or information. However, once the photograph 22 is scanned by the machine 46, the machine detects the digital watermark and code and links to the sponsor's desired document, file, webpage, etc. and displays such on the display 48 of the device 46. Such digital watermarks may be placed over the entirety of the photograph 22, or only a portion of the photograph. The imperceptible digital watermarks may be embedded into images, behind text, etc. and are readily detectible by many machines, including smart phones and the like.

Although several embodiments have been described in detail for purposes of illustration, various modifications may be made to each without departing from the scope and spirit of the invention. Accordingly, the invention is not to be limited, except as by the appended claims.

What is claimed is:

1. A method for providing sporting event photographs, comprising the steps of:
capturing multiple photographs of sporting event participants during a sporting event;
utilizing an electronic device to associate a machine readable code or image with each selected photograph; and
transferring the selected photograph containing the machine readable code or image to a requester;
wherein upon using a machine to read the machine readable code or image, a digital document, a digital file or a web page linked to a sponsor or photographer of the photograph is displayed on an electronic display associated with the machine.

2. The method of claim 1, including the steps of associating identifying data with each photograph taken and storing the photographs in an electronic database, and accessing the electronic database and searching for a photograph utilizing the identifying data and selecting a photograph.

3. The method of claim 1, wherein the machine readable code or image is visible to the human eye.

4. The method of claim 1, wherein the machine readable code or image is not visible to the human eye.

5. The method of claim 1, wherein the machine readable code or image comprises a holograph.

6. The method of claim 1, wherein the machine readable code or image comprises a quick response code.

7. The method of claim 1, wherein the machine readable code or image comprises a bar code.

8. The method of claim 1, wherein the machine readable code or image comprises a magnetic code.

9. The method of claim 1, including the step of associating visual advertiser or photographer indicia with the photograph.

10. The method of claim 1, including the step of using an electronic device to create a field within the photograph and inserting the machine readable code or image, visual advertiser or photographer indicia within the field.

11. The method of claim 10, wherein the field is created in a corner or margin of the photograph.

12. The method of claim 2, wherein the associating step comprises the step of associating at least one of: a time the photograph was captured, a name of the individual photographed, a number worn by the individual photographed, or a code from a device worn by the individual photographed.

13. The method of claim 2, wherein the accessing step comprises the step of accessing the database at a location other than at the event.

14. The method of claim 1, including the step of posting one or more photographs of a low quality resolution or containing a watermark in response to an identifying data search.

15. The method of claim 14, including the step of providing a final high resolution photograph without a watermark after the photograph has been selected and ordered and into which the machine readable code or image has been associated.

16. The method of claim 1, wherein the transferring step comprises the step of downloading the digital photograph containing the field to the requester's electronic device.

17. The method of claim 1, wherein the transferring step comprises the step of electronically mailing the digital photograph containing the field or a link to the digital photograph containing the field to the requester.

18. The method of claim 1, including the step of offering the photograph containing the machine readable code or image to the requester at a reduced fee or for free.

19. The method of claim 2, wherein the storing step comprises the step of storing the photographs in a network accessible server.

20. The method of claim 1, wherein the machine readable code or image is permanently associated with the photograph.

21. A method for providing sporting event photographs, comprising the steps of:
capturing multiple photographs of sporting event participants during a sporting event;
associating identifying data with each photograph taken and storing the photographs in an electronic database;
accessing the electronic database and searching for a photograph utilizing the identifying data and selecting a photograph;
using an electronic device to create at least one field within the photograph;
utilizing an electronic device to permanently associate a machine readable code or image with the created field of the photograph; and
transferring the selected photograph containing the machine readable code or image to a requester;
wherein the machine readable code or image comprises a holograph, a quick response code, a bar code, a magnetic code, or sponsor or photographer scanable indicia; and
wherein upon using a machine to read the machine readable code or image, a digital document, a digital file or a web page linked to a sponsor or photographer of the photograph is displayed on an electronic display associated with the machine.
